(19) United States
(12) Patent Application Publication
(10) Pub. No.: US 2011/0162412 A1
(43) Pub. Date: Jul. 7, 2011

(54) METHODS FOR MANUFACTURING MOLDING DIE, GLASS GOB, AND GLASS MOLDED ARTICLE

(76) Inventors: Naoyuki Fukumoto, Hyogo (JP); Shunichi Hayamizu, Hyogo (JP); Kento Hasegawa, Osaka (JP)

(21) Appl. No.: 12/998,084

(22) PCT Filed: Sep. 10, 2009
(86) PCT No.: PCT/JP2009/065818

§ 371 Date: Mar. 16, 2011

(30) Foreign Application Priority Data
Sep. 19, 2008 (JP) 2008-240616

(51) Int. Cl. C03B 11/08; C03B 11/06; B24B 1/00

(52) U.S. Cl. 65/66; 65/122; 451/36

(57) ABSTRACT

Disclosed is a lower molding die that can well prevent the occurrence of an air bubble without narrowing the range of choice for materials for the lower molding die and, at the same time, is highly durable. Also disclosed is a method for manufacturing a molding die for molding molten glass droplets. The method comprises a step of machining a molding surface of the molding die, a polishing step of polishing the molding surface to an arithmetic average roughness (Ra) of not more than 10 nm after the machining step, a step of forming at least one cover layer on the surface of the molding surface after the polishing step, and a step of roughening the surface of the cover layer formed on the molding surface.

### TECHNICAL FIELD

The present invention relates to a method for manufacturing a molding die used for molding a molten glass droplet, a method for manufacturing a glass gob and that for manufacturing a glass molded article each by using the molding die manufactured by the manufacturing method.

### BACKGROUND ART

Recently, glass optical elements are widely used as a lens for digital cameras, a pickup lens for DVDs, a lens for portable telephone cameras, and a coupling lens for optical communication. As such glass optical elements, glass molded articles formed by press-molding glass material in a molding die are frequently used.

As one of the manufacturing methods for such glass molded articles, there is known a method (hereinafter also referred to as reheat press method), in which method a glass gob having a predetermined mass and shape is made and the glass gob is heated together with a molding die to a temperature at which the glass becomes deformable, and the glass gob is then press-molded with the molding die. Conventionally, the glass gobs used for a reheat press method were often manufactured by grinding and polishing, etc., but there was a problem of requiring a great time and effort in producing a glass gob by machining. Therefore, there is investigated a method in which molten glass is dropped onto a lower molding die from above and the dropped molten glass droplet is cooled and solidified on the lower molding die to prepare a glass gob without any machining.

On the other hand, as other methods for manufacturing glass molded articles, there are proposed a method in which a molten glass droplet dropped on a lower molding die from above is press-molded with the lower molding die and an upper molding die facing the lower molding die to make a glass molded article and a method in which additional side molding die is used to form a side surface of a glass molded article. Those methods are gathering attentions because heating and cooling of the molding die is not required, a glass molded article can be directly shaped from a molten glass droplet, and the time necessary for each molding is short.

However, those methods have a problem that when press-molding a dropped molten glass droplet with an upper molding die, an lower molding die, and a side molding die to manufacture a glass gob or a glass molded article, air is included in the boundary surface where the molten glass droplet is in contact with the molding dies, whereby the included air is left on the surface of the molded article as a depressed portion (air bubble).

As a countermeasure to such a problem, there is proposed a method in which the surface of the mold is roughened (Rmax of from 0.05 μm to 0.2 μm) to save a escape rout for the air included in the depressed portion to escape so as to prevent an air bubble from remaining (for example, Patent Document 1).

Moreover, there is proposed a lower molding die in which a coating layer is provided on the surface of the molding die having Ra of from 0.005 μm to 0.05 μm to facilitate reuse of the molding die, in addition to preventing air bubble (for example, Patent Document 2).

### RELATED ART DOCUMENT

### Patent Document

Patent Document 1: Japanese Laid-Open Patent Application Publication No. H03-137031
Patent Document 2: Japanese Laid-Open Patent Application Publication No. 2005-272187

### DISCLOSURE OF THE INVENTION

### Object of the Invention

If the methods described in Patent Documents 1 or 2 are used to prevent the air bubble from being created, it is necessary to roughen the surface of the molding die to have a predetermined roughness by etching and the like.

There are various constraint conditions on the material to be used for the molding die for press-molding glass, and many conditions must be satisfied as follows: the material does not easily reacts with glass at high temperature; a mirror surface can be obtained; the material can be easily processed; and the material is high in the hardness and low in the brittleness. The materials satisfying such conditions are limited, and tungsten carbide, ceramic material such as silicon carbide and silicon nitride and a composite material are preferably used.

Although these materials have preferable properties for a molding die, it is often difficult to uniformly roughen at a predetermined roughness by a normal wet etching or dry etching. Further, in the case of ultra hard material mainly composed of tungsten carbide, for example, its surface can be roughened by etching, but the formed roughened surface is very brittle and the durability is considerably low.

Therefore, when such materials were used for a molding die, there was a problem that the method described in Patent Documents 1 or 2 cannot be performed, otherwise, a stable manufacture is not realized even if they are performed.

The present invention has been conceived based on the above background, and an object of the invention is to provide a process for manufacturing a lower molding die for receiving a dropping molten glass droplet, which molding die has a good durability and suitably prevents the occurrence of air bubble without limiting options in materials for molding dies. Another object of the invention is to provide a method for stably producing glass gobs having no air bubble and a method for producing glass molded articles having no air bubble.

### Means for Solving the Object

In order to solve the objects, the present invention has the following features.

Item 1. A method for manufacturing a molding die for molding a molten glass droplet, the method comprising the steps of:

machining the molding die to make a molding surface;

polishing, after the step of machining the molding die, so that the molding surface has an arithmetic mean roughness Ra of 10 nm or less;

forming, after the step of polishing, at least not less than one cover layer on the molding surface; and

roughening a surface of the cover layer.

Item 2. The method of item 1, wherein the step of polishing the molding surface is a step of spraying abrasive agent made of an elastic body with a mean particle size of 0.3 to 0.5 mm and abrasive particles, the abrasive particles being laminated on the elastic body and having a mean particle size of 0.3 to 1.0 μm.

Item 3. The method of item 1 or 2, wherein in the step of roughening, the surface of the cover layer is processed to have an arithmetic mean roughness Ra of 0.01 μm or more and a mean length of a roughness curve element RSm of 0.5 μm or less.

Item 4. The method of any one of items 1 to 3, wherein in the step of roughening, the surface of the cover layer is processed to have an arithmetic mean roughness Ra of 0.2 μm or less.

Item 5. The method of any one of items 1 to 4, wherein at least one layer of the cover layer contains at least one element selected from the group consisting of chrome, aluminum, and titanium.

Item 6. The method of any one of items 3 to 5, wherein the roughening step is a wet etching process.

Item 7. A method for manufacturing a glass gob, the method comprising the steps of:

dropping a molten glass droplet onto a lower molding die;

cooling and solidifying the dropped molten glass droplet on the lower molding die,

wherein the lower molding die is manufactured by the method for manufacturing a molding die of any one of items 1 to 6.

Item 8. A method for manufacturing a molded glass article, the method comprising the step of:

molding a molten glass droplet into the molded glass article by using a molding die manufactured by the method for manufacturing a molding die of any one of items 1 to 6.

### Advantage of the Invention

In the manufacturing method of a molding die of the present invention, the surface of the molding die is subjected to a roughening process after a cover layer is formed on its surface, and it is therefore possible to effectively prevent generation of an air bubble without narrowing the options of materials for a molding die. In addition, the molding surface of the molding die is mirror-polished to have a predetermined surface roughness before forming the cover layer, and thus the cover layer is well adhered and the durability is good. The molding die of the present invention realizes the stable manufacturing of glass gobs and glass molded articles having no air bubble.

### BRIEF DESCRIPTION OF THE DRAWINGS

FIG. 1 is a diagram schematically showing an example of a lower molding die according to the present invention;

FIGS. 2a and 2b are diagrams schematically showing an Oscar polishing machine;

FIG. 3 is a diagram schematically showing a shot mirror-polishing machine;

FIG. 4 is a diagram schematically showing the cross sectional form of abrasive according to the present invention;

FIGS. 5a and 5b are diagrams showing a state of a molten glass droplet 20 dropped on the lower molding die 10;

FIGS. 6a, 6b, and 6c are schematic diagrams showing the detail of A part of FIG. 2b;

FIG. 7 is a flow chart showing an example of a method for manufacturing a glass gob;

FIG. 8 is a diagram schematically showing the state of a lower molding die and the like in step S12;

FIG. 9 is a diagram schematically showing the state of the lower molding die and the like in step S13;

FIG. 10 is a flow chart showing an example of a method for manufacturing a glass molded article;

FIG. 11 is a diagram schematically showing the state of the lower molding die and the like in step S22;

FIG. 12 is a diagram schematically showing the state of the lower molding die and the like in step S23; and

FIG. 13 is a schematic diagram showing the state when using a side molding die to form the side plane of a glass molded article.

### BEST MODE FOR CARRYING OUT THE INVENTION

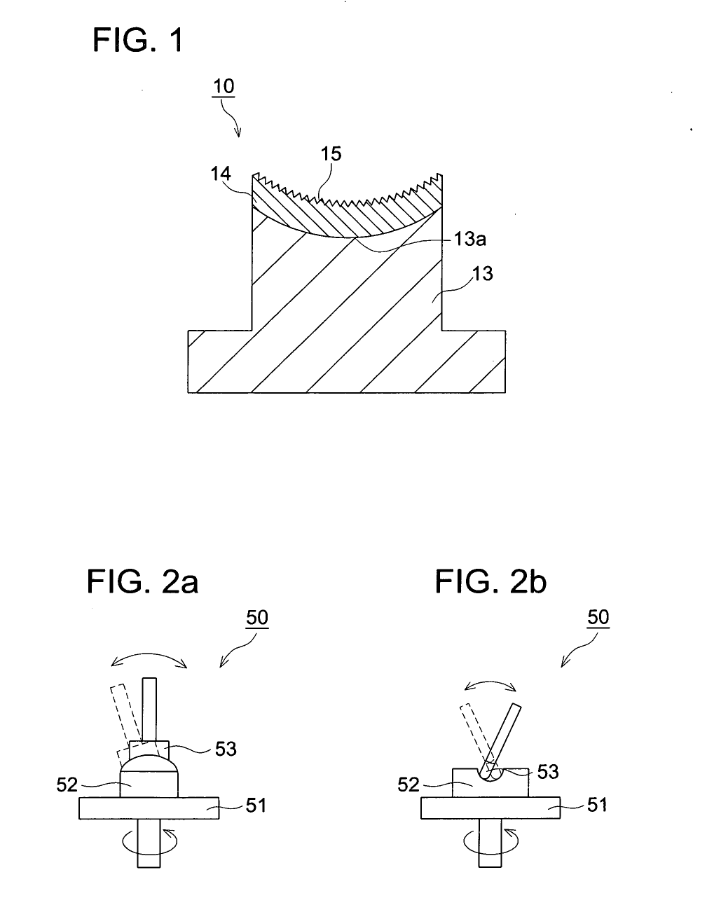

In the following, an embodiment of the invention will be detailed in reference to FIGS. 1 to 13. The explanation is mainly given for a lower molding die as an example of a molding die in the following explanation; however, similar advantages can be obtained not only with a lower molding die but also with an upper molding die and a side molding die.

(Molding Die)

FIG. 1 is a diagram schematically showing a lower molding die as an example of a molding die according to the present invention. The lower molding die 10 shown in FIG. 1 includes a molding die base 13 and a cover layer 14 formed on the molding die base 13.

A molding surface 13a of the molding die base 13 is subjected to machining to have a shape for molding by use of a lathe and the like. On the surface of the molding surface 13a after machining, tool marks of a machining tool such as a turning tool used for processing remains. The surface of the molding surface 13a is polished by using a polishing machine to eliminate these tool marks to have an arithmetic mean roughness (Ra) of 10 nm or less.

As a method for polishing to eliminate tool marks, for example, a method for polishing by sliding a polishing tool on the surface to be polished or a method for polishing by spraying abrasive can be employed. In particular, preferable is the method to spray abrasive, which comprises an elastic body having a mean particle size of 0.3 to 0.5 mm and abrasive particles having a mean particle size of 0.3 to 1.0 μm laminated thereon, against the molding surface after machining. In particular, it is possible to perform polishing by spraying the above-described abrasive on the molding surface of a molding die base by using a shot mirror-polishing machine, and this process takes a short time.

As a specific example of a method for polishing by sliding a polishing tool on the surface to be polished, an Oscar polishing machine and the like can be used. In FIGS. 2a and 2b, schematic diagrams of Oscar polishing machine 50 are shown. In an Oscar polishing machine, a work-piece 52 on a rotating wrap 51 is polished by a polishing tool 53 sliding in circular-arc-wise on the work-piece.

Compared to the method of polishing by sliding a polishing tool on the surface to be polished such as an Oscar polishing machine, the method for polishing by spraying the above described abrasive is more preferred because it is free from shape deformation due to wear of the tool and requires no exchange of tools, thereby exhibiting high productivity.

For example, in the case of polishing 50 pieces of molding dies having been subjected to a machining process to form a precise aspheric surface by using an Oscar polishing machine, an average processing time is approximately 60 minutes for one piece and shape deformation can be caused due to wear of a polishing tool, therefore, approximately 10 times of exchange of tools are required during polishing 50 pieces of molds. On the other hand, in the case of a shot mirror-polishing machine using the above described abrasive, there was caused no ware of tools, and it took only 5 minutes in average to process one piece without changing tools.

When the mean particle size of an elastic body used in a shot mirror-polishing machine is larger than 0.5 mm, it becomes difficult to uniformly spray abrasive on the molding surface, thereby deforming the shape of the molding surface from a predetermined shape. The elastic body with a particle size smaller than 0.3 mm is not preferable because the life of the abrasive is short. Further, when the mean particle size of abrasive particles is larger than 1.0 μm, the polishing amount by one abrasive particle is large at the time of spraying the abrasive on the molding surface resulting in difficulty in making the arithmetic mean roughness (Ra) of the molding surface of 10 nm or less. While, when it is smaller than 0.3 μm, the polishing amount by one abrasive particle is small, thereby increasing polishing time and resulting in lower productivity.

Herein, a mean particle size of the above-described elastic body and abrasive particle were measured with a particle size analyzer (SALD2200, manufactured by Shimadzu Corp.).

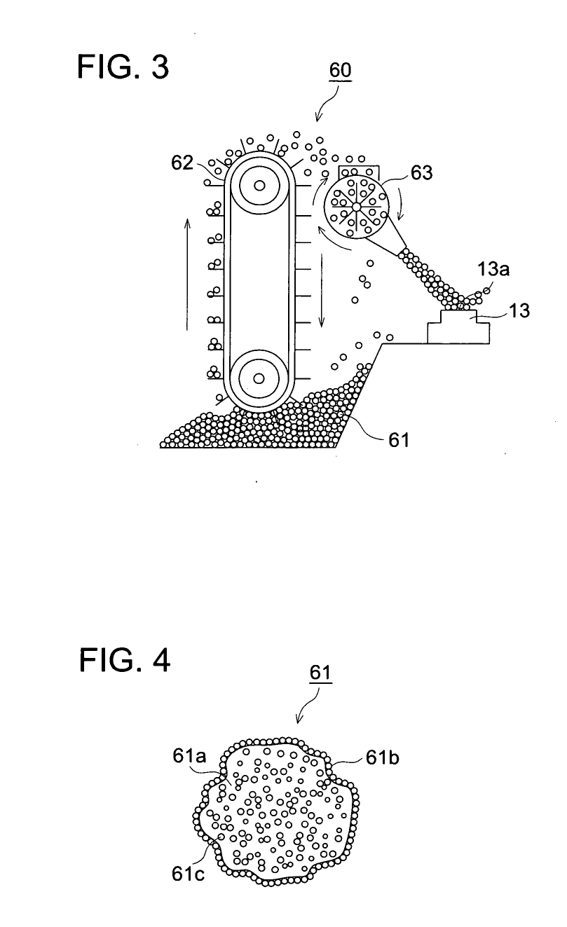

FIG. 3 shows shot mirror-polishing machine 60. Abrasive 61 is conveyed to a spraying device 63 by a belt conveyer 62 and the abrasive 61 is sprayed together with air from the spraying device 63 on the molding surface 13a of the molding die base 13.

A cross-sectional shape of the abrasive 61 is schematically shown in FIG. 4. The abrasive 61 is constituted by an elastic body 61a having a mean particle size of 0.3 to 0.5 mm and abrasive particles 61b having a mean particle size of 0.3 to 1.0 μm laminated thereon. Air bubbles 61c may be present inside the elastic body.

The elastic body 61a used for the abrasive 61 is, for example, a carrier in a particle form for adhesively supporting the abrasive particles 61b and can be made of an viscoelastic material. The common one is adhesive. Adhesive is classified into an acryl type, a rubber type, a vinyl type, a silicone type, and the like based on the kind of a base polymer, and can be selected from any of them in the present invention. However, since each adhesive has different viscous characteristics and elastic characteristics, the most preferable one should be selected on the basis of the finishing purpose. In this respect, since an acryl type and a rubber type are representatives and are available at a low cost, they are preferably selected as a core material for general finishing. In particular, acryl type adhesives are easy to change the physical properties by copolymerization with other monomer and have advantages of excellent durability and oil resistance compared to rubber type adhesives. While, rubber type adhesives have an advantage of adhering to any polishing fine particles since it exhibits tackiness regardless of the polarity of a body to be adhered although being inferior in durability compared to an acryl type. Herein, rubber type adhesives are not necessarily limited to natural rubber but can be selected from synthetic rubbers. On the other hand, since silicone type adhesives are excellent in heat resistance, weather resistance and chemical resistance, they can be selected for small change in such physical properties.

As the abrasive particles 61b, for example, diamond powder and abrasives such as silicon carbide and alumina crushed to a predetermined particle size can be used.

Such abrasive 61 can be prepared by sticking the abrasive particles 61b to the surface of the adhesive elastic body 61a, and is described in Japanese Laid-open Patent Application Publication No. 2004-91510.

By spraying such abrasive 61 on the molding surface 13a of the molding die base 13 by ejecting from a shot mirror-polishing machine 60, a mirror surface having an arithmetic mean roughness (Ra) of 10 nm or less can be formed in a short polishing process time on the molding surface 13a of the molding die base 13 with little shape error.

The molding surface (aspherical shape) of a molding die base made of tungsten carbide was subjected to a polishing process using a shot polishing machine (mirror shot machine SMAP) manufactured by Toyo Kenmazai Kogyo, and the types of the used abrasives, polishing conditions and the evaluation results of the polishing are shown in Table 1. As a material of the elastic body of the abrasives, synthetic rubber was used. The evaluation was made by measuring the degree of deformation from a predetermined shape and the surface roughness. Those having an error greater than 1 μm from a predetermined shape were ranked E, those having an error greater than 0.5 μm and not greater than 1 μm were ranked D, those having an error greater than 0.2 μm and not greater than 0.5 μm were ranked C, and those having an error of not greater than 0.2 μm were ranked B. Further, as polishing properties, those having an arithmetic mean roughness (Ra) of the molding surface greater than 30 nm were ranked E, those having Ra greater than 20 nm and not greater than 30 nm were ranked D, those having Ra greater than 10 nm and not greater than 20 nm were ranked B and those having Ra of not greater than 10 nm were ranked C. Herein, the frequency of the rotation blade can be set to a range of 10 to 60 Hz, and the collision force against the molding surface is the larger as the frequency of the rotation blade is the larger.

TABLE 1

| | Abrasive | | | | | | |
|---|---|---|---|---|---|---|---|
| | Mean particle | | Mean particle | | | | |
| | size of elastic | Material of | size of abrasive | Frequency of | | Evaluation result | |
| | body | abrasive | particle | rotation blade | Processing time | Deformation | Surface |
| | (mm) | particle | (μm) | (Hz) | (min) | of shape | roughness |
| Polishing conditions 1 | 0.15 | Diamond | 4.5 | 30 | 1 | E | E |
| Polishing conditions 2 | 0.15 | Diamond | 4.5 | 20 | 1 | D | D |
| Polishing conditions 3 | 0.15 | Diamond | 4.5 | 10 | 1 | B | C |
| Polishing conditions 4 | 0.15 | Diamond | 4.5 | 10 | 2 | C | C |
| Polishing conditions 5 | 0.40 | Alumina | 0.3 | 30 | 1 | B | C |
| Polishing conditions 6 | 0.40 | Alumina | 0.3 | 60 | 60 | B | C |
| Polishing conditions 7 | 0.40 | Diamond | 0.5 | 20 | 1 | B | C |
| Polishing conditions 8 | 0.40 | Diamond | 0.5 | 20 | 5 | B | B |
| Polishing conditions 9 | 0.40 | Diamond | 0.5 | 20 | 10 | D | B |

It is clear from the results for the polishing conditions 1 to 4 of Table 1 that a large collision force causes deformation of shape and large surface roughness in the case of using elastic bodies having a mean particle size of 0.15 mm and diamond (mean particle size of 4.5 μm) as abrasive particles. The deformation of shape is smaller for the smaller collision force, however, mirror polishing of 10 nm or less is not achieved. Even the long processing time and small collision force does not realize mirror polishing, instead causes deformation of shape. Further, it is clear from the results for the polishing conditions 5 and 6 that in the case of using elastic bodies having a mean particle size of 0.4 mm and alumina (a mean particle size of 0.3 μm) as abrasive particles, there was caused no deformation of shape, however, mirror polishing could not be achieved even when varying collision force and a processing time. Further, it is clear from the results of the polishing conditions 7 to 9 that in the case of using elastic bodies having an particle size of 0.4 mm and diamond (mean particle size of 0.5 μm) as abrasive particles, obtained are the conditions to enable mirror polishing of 10 nm or less without deformation of the shape in a processing time of as short as 5 minutes.

By making the arithmetic mean roughness (Ra) of the molding surface of a molding die base to be 10 nm or less, it is possible to enhance adhesion of a cover layer formed thereon to improve durability of a molding die. Further, in a process to provide a cover layer formed on the molding surface of a molding die base with a roughening process, a cover layer will never be peeled off, by a shock in a roughening process, from the molding surface, and it is thus possible to decrease a manufacturing cost.

Returning to FIG. 1, after polishing the molding surface of the molding die base 13 which has been machined, the cover layer 14 is formed thereon. Thereafter, a surface 15 of the cover layer 14 is subjected to a roughening process to increase the arithmetic mean roughness (Ra) so that the arithmetic mean roughness (Ra) and the mean length of a roughness curve element (RSm) fall within a predetermined range.

In this manner, in the present invention, it is not necessary to roughen the molding die base 13 before formation of cover layer 14 because a roughening process is provided to the cover layer 14 formed on the molding die base 13 having been polished. Therefore, the material for the molding die base 13 can be selected without considering easiness of roughening, durability in the case of being roughened, or the like.

Therefore, the material of molding die base 13 is not specifically limited and can be appropriately selected and used from among materials well known in the art as material for a molding die depending on conditions. Preferably usable materials include, for example, various kinds of heat resistant alloys (such as stainless steel), super hard materials comprising tungsten carbide as a primary component, various kinds of ceramics (such as silicon carbide, silicon nitride, and aluminum nitride) and complex materials containing carbon.

The material for the cover layer 14 is also not specifically limited, and there can be used, for example, various kinds of metals (such as chromium, aluminum, and titanium), nitrides (such as chromium nitride, aluminum nitride, titanium nitride, and boron nitride) and oxides (such as chromium oxide, aluminum oxide, and titanium oxide).

Among them, a metal layer comprising at least one of chromium, aluminum, and titanium is specifically preferable. Chromium, aluminum, and titanium not only have advantages of easy formation and easy roughening by etching but also are characterized by forming a stable oxide layer by oxidation of the surface by heating in the air. Any one of oxides of chromium, aluminum, and titanium has a great advantage of being very stable and not easily reacting even in contact with high temperature molten glass because it has a small standard free energy of formation (standard Gibb's energy of formation).

The thickness of the cover layer 14 may be thick enough to obtain a predetermined arithmetic mean roughness (Ra) by roughening after being formed, and is typically preferably 0.05 μm or more. On the other hand, there may be a case to easily generate defects such as peeling when the cover layer 14 is excessively thick. Therefore, the thickness of the cover layer 14 is preferably 0.05 to 5 μm and more preferably 0.1 to 1 μm.

A method for formation of the cover layer 14 is also not limited and may be appropriately selected from among formation methods well known in the art. Listed are vacuum evaporation, spattering and DVD, and the like.

After the cover layer 14 is formed, a roughening process for increasing the arithmetic mean roughness (Ra) of the surface 15 of the cover layer 14 is provided. A roughening process is preferably conducted so as to make the arithmetic mean roughness (Ra) of the surface 15 of the cover layer 14 be not smaller than 0.01 μm and the mean length of a roughness curve element (RSm) be not greater than 0.5 μm. In this manner, it is possible to prevent the occurrence of an air bubble in a glass gob or a glass molded article which have been manufactured by dropping a molten glass droplet from above onto the lower molding die 10.

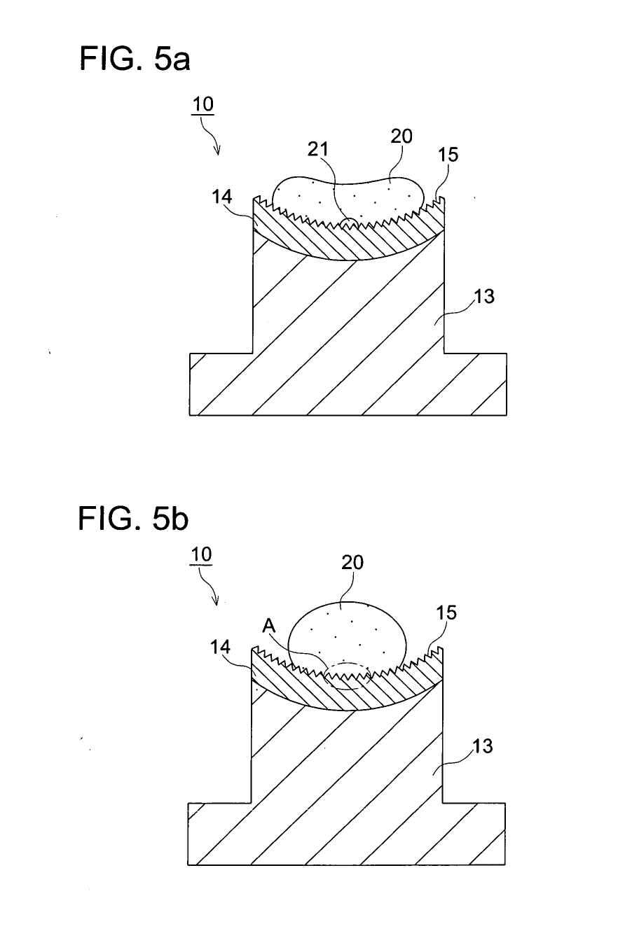

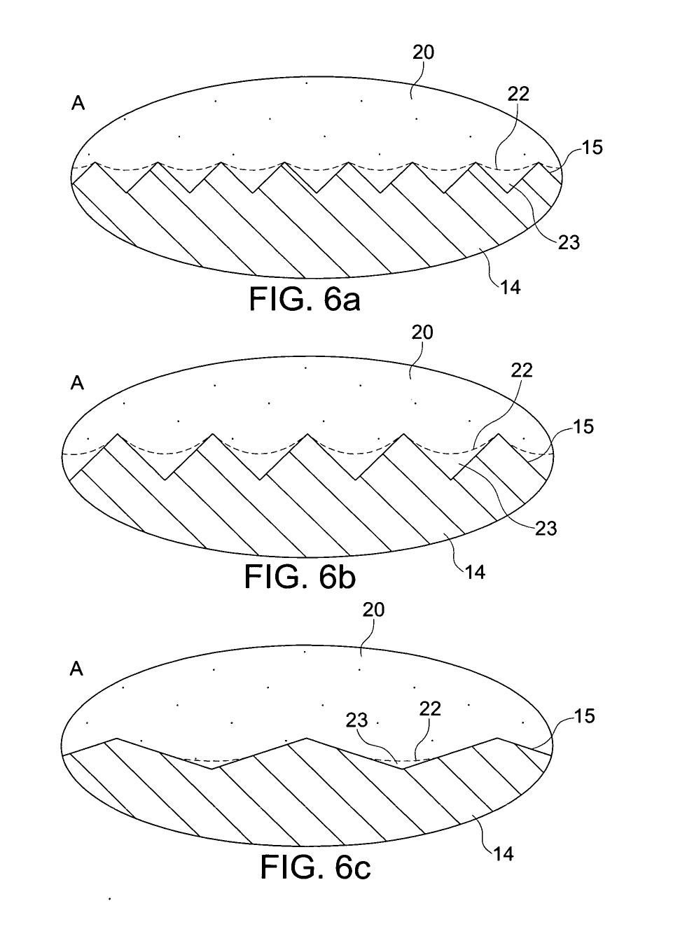

The reason why it is possible to prevent the occurrence of an air bubble in a glass gob or a glass molded article by providing the surface 15 of the cover layer 14 by a roughening process will now be explained in reference to FIGS. 5a, 5b, 6a, and 6b.

FIGS. 5a and 5b is a diagram showing a state of a molten glass droplet 20 dropped on the lower molding die 10. FIG. 5a shows the state at the moment when the molten glass droplet 20 has just landed on the lower molding die 10, and FIG. 5b shows the state of the molten glass droplet 20 which has got rounded due to a surface tension.

As shown in FIG. 5a, the molten glass droplet 20, at the moment when having just landed on the lower molding die 10, is extended flat by the shock of collision. At this moment, in the molten glass droplet 20, a small concave part 21 having a diameter of a few tens μm to a few hundreds μm is generated in the neighborhood of the center of its lower surface (which is the surface in contact with the cover layer 14).

The molten glass droplet 20 then deforms to be rounded by a surface tension, as shown in FIG. 5b. At this time, if the surface 15 of the cover layer 14 has not been subjected to a roughening process, the lower surface of the molten glass droplet 20 and the cover layer 14 adhere to each other, thereby making no escape path for the air included in the concave part 21, and concave part 21 thus will not disappear and will remain as an air bubble.

However, the surface 15 of the cover layer 14 of the lower molding die 10 according to this embodiment is a surface having been subjected, after being formed, to a roughening process to increase the arithmetic mean roughness (Ra). Therefore, gaps remain between the lower surface of the glass droplet 20 and the cover layer 14, and when the molten glass droplet 20 deforms to get rounded by a surface tension, the air bubble included in the concave part 21 will escape through the gaps, thereby extinguishing the concave part 21.

The state of the gaps generated between the lower surface of the molten glass droplet 20 and the cover layer 14 will be further detailed in reference to FIGS. 6a and 6b. FIGS. 6a and 6b are schematic diagrams showing the detail of A part of FIG. 5b. As shown in FIG. 6a, the surface 15 of the cover layer 14 is provided with concavity and convexity by the roughening process. The lower surface 22 of the molten glass droplet 20 does not completely enter into the valley parts of the roughness on the surface 15 of the cover layer 14 due to a surface tension, leaving the gaps 23. The gaps 23 functions as escape paths for air included in the concave part 21, thereby extinguishing the concave part 21.

The inventors of the present invention have found as a result of extensive study that it is preferable to make the surface 15 of the cover layer 14 have an arithmetic mean roughness (Ra) of not less than 0.01 μm and a mean length of a roughness curve element (RSm) of not greater than 0.5 μm by created by the roughening process, which can effectively extinguish the concave part 21.

Herein, the arithmetic mean roughness (Ra) and the mean length of a roughness curve element (RSm) are roughness parameters defined in JIS B 0601:2001. In the present invention, the measurement of these parameters is conducted with a measurement apparatus having a spatial resolution of not greater than 0.1 μm such as an AFM (atomic force microscope). A general stylus type surface roughness tester is not preferred because the curvature radius at the top of a stylus is as large as a few μm or more.

In the case that the height of the roughness of the surface 15 is small and the arithmetic mean roughness (Ra) is less than 0.01 μm, glass will enter into the most portion of the valley of the roughness, thereby forming the gaps 23 having insufficient size, as a result the concave part 21 does not completely disappear but remains. Therefore, it is preferable to make the arithmetic mean roughness (Ra) of 0.01 μm or more.

On the other hand, in the case that the roughness is high as shown in FIG. 6b, the gaps having a sufficient size are formed, thereby easily extinguishing the concave part 21. However, the convexity and concavity in the manufactured glass gob or glass molded article can be too large. Therefore, the surface 15 of the cover layer 14 specifically preferably have an arithmetic mean roughness (Ra) of not more than 0.2 μm.

Further, a cycle of roughness is also important. FIG. 6b shows the case that the height of roughness of the surface 15 is the same as FIG. 6a; however, a cycle of the roughness is larger. In this manner, when the roughness has a larger cycle and the same height, glass enters into the bottom of the valley of the convexity and concavity and the gaps 23 having a sufficient size are not formed, and the concave part 21 is thus not completely distinguished but left. Therefore, the mean length of a roughness curve element (RSm) is preferably set to 0.5 μm or less.

In this manner, by making the arithmetic mean roughness (Ra) and the mean length of a roughness curve element (RSm) of the surface 15 of the cover layer 14 within a predetermined range, sufficient escape paths for air are formed to surely extinguish concave part 21.

Herein, it is not necessary to make the arithmetic mean roughness (Ra) and the mean length of a roughness curve element (RSm) within a predetermined range over the whole area of the surface 15 of the cover layer 14, and it is acceptable that at least the region of the surface 15 to be in contact with the molten glass droplet 20 is within a predetermined range.

There is no specific limitation to a method for the roughening process to make the arithmetic mean roughness (Ra) and the mean length of a roughness curve element (RSm) of the surface 15 of the cover layer 14 be within a predetermined range, and wet etching using liquid or dry etching using a reactive gas and the like is preferable to uniformly form a predetermined roughness. In particular, wet etching using liquid can be preferably used since it requires no expensive facilities and can easily form uniform roughness.

Wet etching is a method to form roughness by bringing a reactive etching solution in contact with surface 15 of cover layer 14 to react. The cover layer 14 may be immersed in an etching solution stored or a predetermined amount of an etching solution may be supplied on the cover layer 14. Further, there may be adopted a method to spray an etching solution in a spray form.

An etching solution may be appropriately selected from etching solutions well known in the art depending on materials of the cover layer 14. In the case of the cover layer 14 is made of aluminum, there can be used etching solutions, on the market, such as various acidic solutions which can be preferably used for aluminum. Also in the case of the cover layer 14 is made of titanium, an etching solution preferably used for titanium are available on the market. For example, listed are etching solutions whose primary component is reductive acid such as hydrochloric acid and sulfuric acid.

Further, in the case of the cover layer 14 containing chromium, etching solutions preferably used for chromium are available also on the market. For example, listed is an acidic solution containing ammonium cerium (IV) nitrate and the like. Further, an alkaline solution containing potassium ferricyanide and potassium hydroxide can be also used.

Although the case of the cover layer 14 comprising only one layer is explained as an example in this embodiment, the cover layer 14 may have a multi-layer construction comprising two layers or more. For example, an intermediate layer may be provided to enhance adhesion between the molding die base 13 and the cover layer 14, and a protective layer to protect the surface may be further provided on the cover layer 14, in which convexity and concavity has been formed by a roughening process. In the case of a cover layer comprising not less than two layers, it is preferable to make the arithmetic mean roughness (Ra) and the mean length of a roughness curve element (RSm) of the outermost surface to be in contact with molten glass droplet 20 be within the above-described predetermined range.

Further, in the above-described embodiment, the description was made on the molding die in the case of a lower molding die. However, regarding the upper molding die and the side molding die, the surface of their base may be polished by a polishing process of the present invention, and be provided with a cover layer thereon; and the surface of those cover layer may be roughened, whereby there may be provided molding dies which can be used for a long time and are free from an air bubble, which was conventionally generated.

(Manufacturing Method of Glass Gobs)

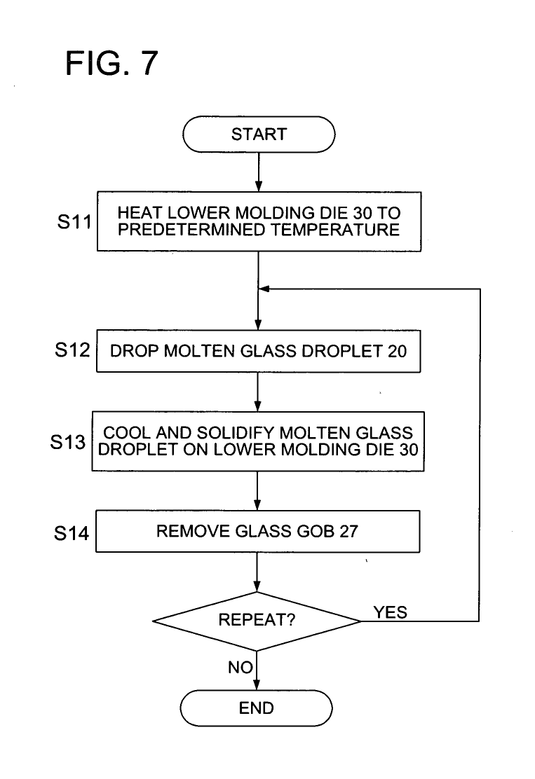

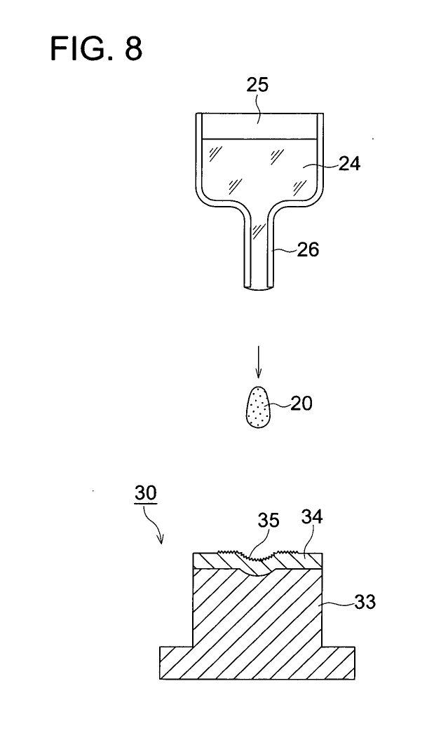

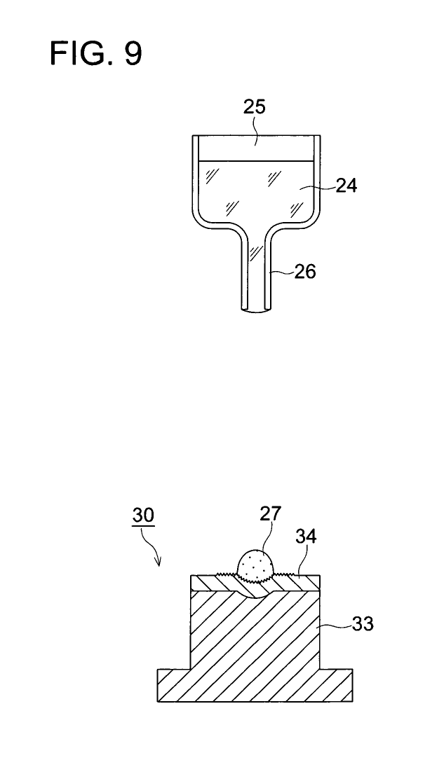

The manufacturing method of glass gobs of the invention is described below referring FIGS. 7 to 9. FIG. 7 is a flowchart illustrating an example of a manufacturing method of glass gobs. FIGS. 8 and 9 are schematic diagrams illustrating a manufacturing method of glass gobs in an embodiment of the invention. FIG. 8 shows a state in step (S12) for dropping a molten glass droplet onto a lower molding die, and FIG. 9 shows a state in step (S13) for cooling and solidifying the dropped molten glass droplet on the lower molding die.

A lower molding die 30 is a molding die manufactured by the method of the present invention, and a cover layer 34 is formed on a lower molding die base member 33. The surface 35 of the part of the cover layer 34 which contacts a molten glass droplet 20 is roughened so that the arithmetic mean roughness (Ra) and the mean length of a roughness curve element (RSm) fall in a predetermined range.

The lower molding die 30 is configured to be heated to a predetermined temperature with a heating section not shown in the drawing. The heating section can be properly selected and used from known heating means. For example, a cartridge heater can be used being buried in a member to be heated, a sheet heater can be used in contact of the outer surface of the member to be used, or an infrared heating device or a high frequency induction heating device and the like can be used.

Above the lower molding die 30, there is arranged a melting bath 25 for storing molten glass 24 and the nozzle 26 provided in the lower part of the melting bath 25.

The steps are each successively described below according to the flowchart shown in FIG. 7.

First, the lower molding die 30 is heated to a predetermined temperature in advance (step S11). If the temperature of the lower molding die 30 is too low, large wrinkles may be generated in the lower surface (contacting face with the lower molding die 30) of the glass gob, or cracks and crush maybe created by a rapid cool-down. To the contrary, if the temperature is set unnecessarily too high, not only the glass and the lower molding die 30 may be fusion-bonded together and the service life of the molding die may thus be shortened, but an air bubble may remain in the glass gob due to the close contact between the glass and the lower molding die 30. Actually, since appropriate temperature depends on various conditions such as the kind, shape, and size of the glass; the material and size of the molding die; and the locations of the heater and temperature sensor, an appropriate temperature is preferably obtained experimentally in advance. Usually, the temperature is preferably set to about Tg (glass transition point) of the glass −100° C. to Tg+100° C.

Next, the molten glass droplet 20 is dropped onto the lower molding die 30 (step S12). The melting bath 25 is heated by a heater not illustrated, and the molten glass 24 is stored therein. At the lower part of the melting bath 25 is provided with a nozzle 26, at a tip portion of which the molten glass 24 having passed through a flow path provided inside the nozzle 26 is held by the surface tension. When the molten glass held at the tip portion of the nozzle 26 comes to a predetermined mass, it separates from the tip portion of the nozzle 26 to be a molten glass droplet 20 with a predetermined mass, and falls downward (FIG. 20).

In general, the mass of the molten glass droplet 20 to be dropped can be adjusted by adjusting the outer diameter of the tip portion of the nozzle 26, glass of 0.1 g to 2 g can be dropped although it depends on the type of glass. Further, the interval between the drops of the glass droplet can be adjusted by adjusting the inner diameter and length of the nozzle 26 and the heating temperature. Therefore, it is possible to drop a molten glass droplets of a predetermined mass at predetermined intervals, by appropriately setting these conditions.

There is no restriction in particular in the type of glass which can be used, and it is possible to select and use from known glass, depending on application. Examples include optical glass such as a borosilicate glass, silicate glass, phosphate glass, and a lanthanum system glass.

Further, instead of dropping the molten glass droplet from the nozzle directly onto the lower molding die, the molten glass droplet released from the nozzle may be crashed against a member having a fine through-hole, whereby a part of the crashing glass droplet may go through the fine through-hole to be a fine droplet and may fall onto the lower molding die. By this method, a fine glass gob can be manufactured. This method is described in detail in Japanese Laid-open Patent Application Publication No. 2002-154834.

Next, the dropped molten glass droplet 20 is cooled and solidified on the lower molding die 30 (step S13) (FIG. 9). By leaving the molten glass droplet 20 for a predetermined time on the lower molding die 30, the molten glass droplet 20 is cooled by the heat dissipation to the lower molding die 30 and the air, and is solidified. Since the surface 35 of the portion in contact with the molten glass droplet 20 has been subjected to the prescribed surface roughening process, an air bubble will not be generated in the solidified glass gob 27.

Then, the solidified glass gob 27 is removed (step S14), and the glass gob is thus completed. The remove of the glass gob 27 can be performed by using, for example, a known removal device using vacuum contact. When the glass gob will be successively manufactured, step S12 and the following steps can be performed.

The glass gob manufactured by the manufacturing method of this embodiment can be used to manufacture various precise optical elements by a reheat press method.

(Manufacturing Method of Glass Molded Article)

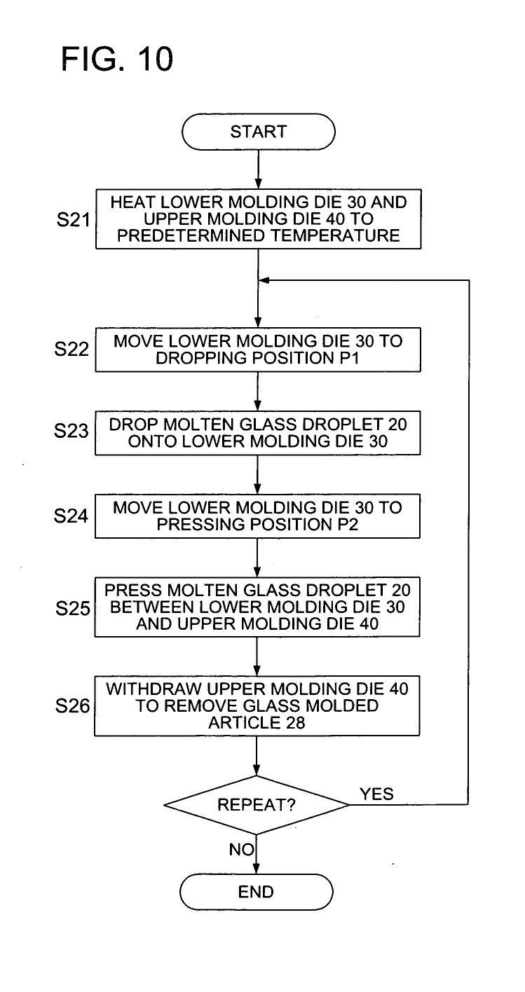

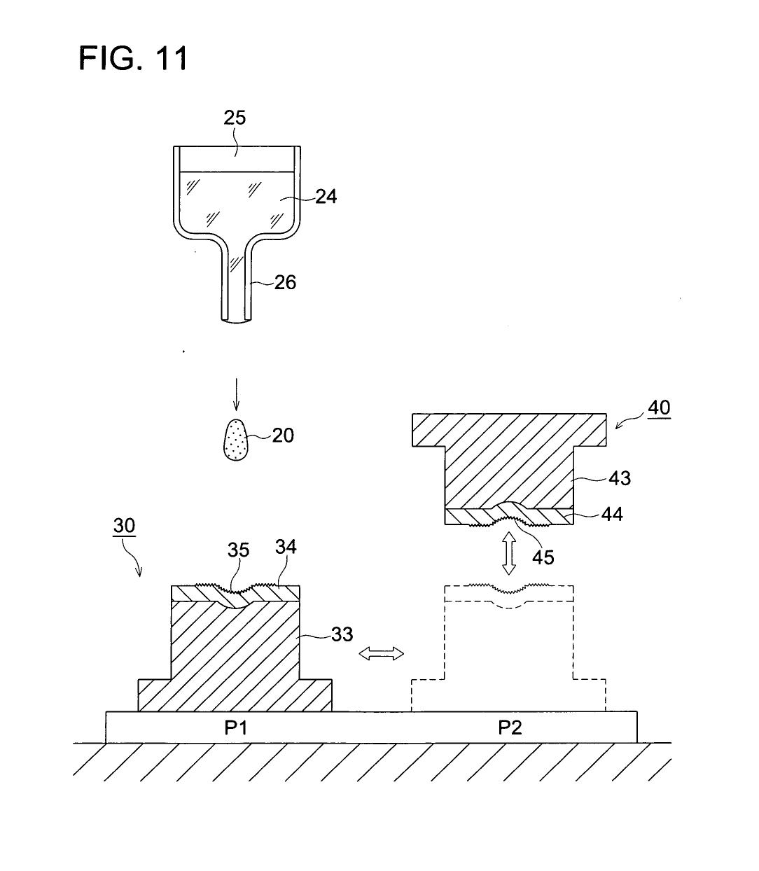

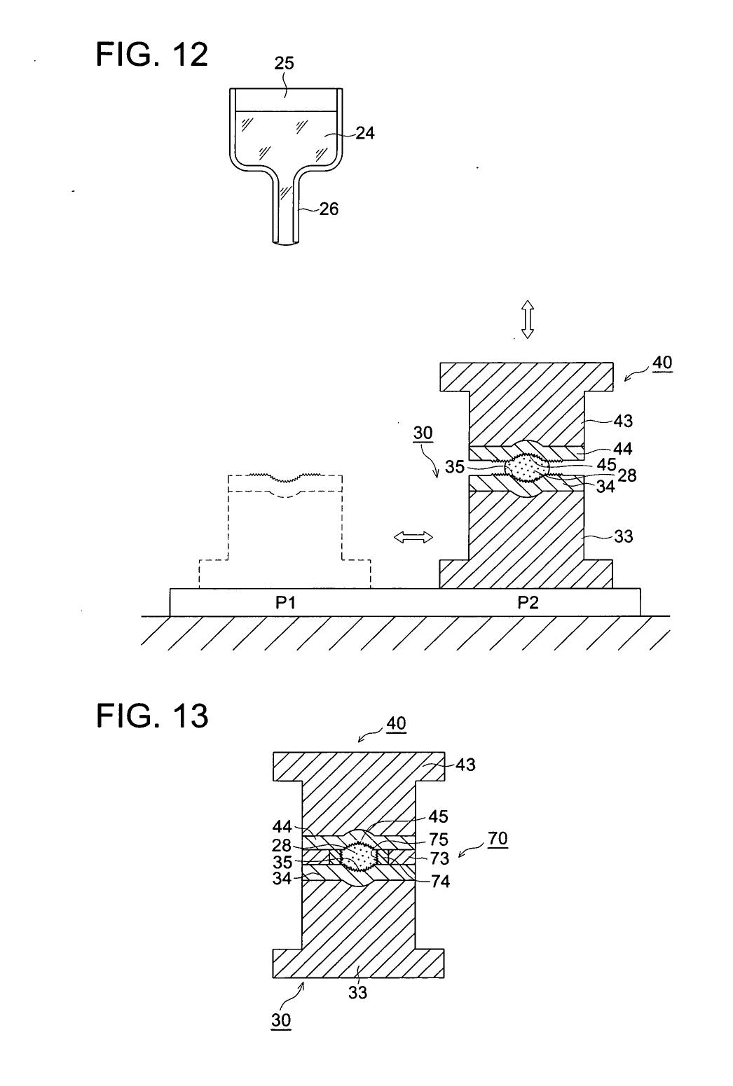

The manufacturing method of glass molded articles of the present invention is described below referring to FIGS. 10 to 12. FIG. 10 is a flowchart illustrating an example of a manufacturing method of a glass molded article. FIGS. 11 and 12 are schematic diagrams illustrating the glass molded article manufacturing method in an embodiment of the invention. FIG. 11 shows a state in step (S23) for dropping the molten glass droplet onto the lower molding die, and FIG. 12 shows a state in step (S25) for pressing the dropped molten glass droplet with the upper molding die and the lower molding die.

The lower molding die 30 is the same molding die as that described in FIGS. 8 and 9. The upper molding die 40 is made of the same material as that of the lower molding die 30, and includes an upper molding die base 43 having been polished by the shot mirror-polishing machine 60 as the lower molding die has been done, and a cover layer 44 formed of the same material as the lower molding die 30. A surface 45 of the cover layer 44 is roughened as the lower molding die is done.

The lower molding die 30 is configured to be movable, by a driving means not shown in the drawing, between the position (dropping position P1) to receive the molten glass droplet 20 under the nozzle 23 and the position (pressing position P2) to face the upper molding die 40 and press the molten glass droplet 20 with the upper molding die 40. The upper molding die 40 is configured to be movable, by a driving means not shown in the drawing, in the direction (top and bottom direction in the drawing) to press the molten glass droplet with the lower molding die 30.

The steps are described below one by one according to the flowchart shown in FIG. 10.

First, the lower molding die 30 and the upper molding die 40 are heated at a predetermined temperature in advance (step S21). The lower molding die 30 and the upper molding die 40 are configured to be heated to the predetermined temperature by a heating means not shown in the drawing. The lower molding die 30 and the upper molding die 40 are preferably configured such that their temperatures are each independently controlled. The predetermined temperature is a temperature which may be suitably selected in the same way as a predetermined temperature is selected at step S11 of the aforementioned manufacturing method of a glass gob, so that a good surface is formed on the glass molded article by a press-molding method. The temperature of the lower molding die 30 and that of the upper molding die 40 may be the same or different.

Next, the lower molding die 30 is moved to the dropping position P1 (step S22), and the molten glass droplet 20 is dropped from the nozzle 26 (step S23) (FIG. 11). The conditions for the dropping of the molten glass droplet 20 are the same as those in the case of step S12 for producing the glass gob.

Then the lower molding die 30 is moved to the pressing position P2 (step S24), and the upper molding die 40 is moved downward to press the molten glass droplet 20 with the lower molding die 30 and the upper molding die 40 (step S35); (FIG. 12).

The molten glass droplet 20 is cooled with the heat being dissipated through the surfaces contacting with the lower molding die 30 and the upper molding die 40 while being pressed, and is solidified. The pressing is released after the molten glass droplet 20 is cooled to a temperature at which the transferred surface formed on the glass molded article is not deformed even when the pressure is released.

It is usually suitable that the temperature is lowered to a temperature near the Tg of the glass although the temperature is depending on the kind of glass, the size, shape and the precision required for the glass molded article. The load applied to press the molten glass droplet 20 may be constant or varied with time. It is preferred to put a load greater than a prescribed value until the molten glass droplet 20 is cooled down to a temperature at which the pressing can be released, so that the lower molding die 30 and the upper molding die 40 can be kept in close contact. The amount of the load may be suitably decided depending on the size of the glass molded article to be produced. The driving means for moving the upper molding die 40 in the vertical direction is not specifically limited, and may be suitably selected from known driving means such as an air cylinder, oil pressure cylinder and servo motor.

The upper molding die 40 is moved upward to remove the solidified glass molded article 26 (step S26), and which completes the production of a glass molded article. No air bubble is formed on the obtained glass molded article since the surface of the coating layers 25 and 45 of the lower molding die 30 and the upper molding die 40 are roughened. When the production of the glass molded article is continued, the lower molding die 30 is returned again to the dropping position P1 (step S32) and the succeeding steps are repeated.

In the method of manufacturing a glass molded article of the present invention, a side molding die 70 can be used between the upper molding die 30 and the lower molding die 40, as shown in FIG. 13. Regarding the side molding die 70, used is a side molding die base 73 whose surface is roughened and is provided with a cover layer 74 formed thereon, and the surface 75 of the cover layer 74 is roughened as the lower molding die 30 and the upper molding die 40 are done. This arrangement prohibits an air bubble from occurring in the surface of the glass molded article, which surface corresponds to the side molding die 70.

The method of manufacturing a glass molded article of the present invention may include a step other than the above-described steps. For example, a step for examining the shape of the glass molded article before removing the glass molded article, and a step for cleaning the lower molding die 30 and the upper molding die 40 may be provided after removing the glass molded article.

The glass molded articles produced by the manufacturing method of the invention can be used as various kinds of optical elements such as an image taking lens for a digital camera, an optical pickup lens for DVD and a coupling lens for optical communication. The glass molded article may be heated again to be press-molded by the heat press method to produce various kinds of optical elements.

### EXAMPLES

Examples carried out to confirm the effects of the invention are described below, although the invention is not limited thereto.

### Examples 1 to 4

### Comparative Examples 1 and 2

The glass molded article was manufactured according to the flow chart shown in FIG. 10. First, the lower molding die 30 and the upper molding die 40 were prepared. As the material of the lower molding die 30 and the upper molding die 40, the ultra hard material mainly composed of tungsten carbide was used. The lower molding dies 30 and the upper molding dies 40 were made to have a predetermined shape for forming a glass molded article (the external diameter of 7 mm, and 3.5 mm in thickness at the central part). The lower molding die bases 33 and the upper mold bases 43 for the examples and the comparative example were made to have such shapes by precision machining with a lathe and a turning tool. There are tool marks remaining in the processed surfaces after each lathe work.

Then, the lower molding die bases 33 and the upper molding die bases 43 were machined by a mirror shot polishing machine (Toyo Kenmazai Kogyo Co., Ltd. SMAP-2) to remove the tool marks created by the lathe machining and to have predetermined surface roughness's. As abrasive agent used for this polish was made of elastic bodies of synthetic rubber (average diameter of 0.4 μm) coated with abrasive particles of diamond (average diameter of 0.5 μm). The machining conditions (a frequency of the rotation blade of the polishing machine, time duration of polish) were appropriately adjusted so as to obtain the roughness's of Table 2. It should be noted that the machining conditions for each lower molding die base 33 and the upper molding die base 43 was the same.

Next, a cover layer was formed on the surface of each of the lower molding die bases 33 and the upper molding die bases 43. The coating layers 34 and 44 were metallic chromium layers. The metallic chromium layer was formed by a sputtering method and the thickness thereof was 0.5 μm.

Regarding Examples 1 to 4 and Comparative example 1, after the cover layers were formed, the surfaces 35 and 45 of the cover layers 33 and 43 were immersed in etching solution to roughen their surfaces. As the etchant, a chromium etchant available on the market containing cerium (IV) ammonium nitrate (ECR-2, manufactured by Nacalai Tesque Inc.) was used. The lower molding dies 30 and the upper molding dies 40, whose arithmetic average surface roughness (Ra) and average length of roughness curve element (RSm) were shown in Table 2, were prepared by adjusting the etching solution. The arithmetic average surface roughness's (Ra) and the average lengths of roughness curve element (RSm) were measured by the AFM (D3100, manufactured by Digital Instruments). Regarding Comparative example 2, the surfaces 34 and 44 were not roughened after being formed.

Molded glass articles were prepared using the lower molding die 30 and upper molding die 40 according to the flowchart shown in FIG. 10. Phosphoric acid type glass having Tg of 480° C. was used as the glass material. The heating temperature in step S21 of the lower molding die 30 and the upper molding die 40 were 500° C. and 450° C., respectively. The temperature near the end of the nozzle 26 was 1000° C., and the conditions were set so that the molten glass droplets 20 having a weight of about 190 mg were dropped. The load for pressing was 1,800 N.

The glass molded articles produced by the thus prepared lower molding dies 30 and the upper molding dies 40 were checked by microscopic observation whether there were air bubbles. Moreover, the arithmetic average surface roughness (Ra) of the bottom surface (the surface formed in contact with the lower molding die 30) was measured. The arithmetic average surface roughness (Ra) of the bottom surface of the glass molded article was ranked as follows: Not more than 0.1 μm: Excellent (A); More than 0.1 μm and not more than 0.15 μm: Good (B); More than 0.15 μm: acceptable (C).

Using the thus produced lower molding die 30 and the upper molding die 40, 10,000 pieces of glass molded articles were manufactured, and peeling of the cover layer of the lower molding die 30 and the upper molding die 40, which have molded 10,000 pieces, was visually inspected.

The durability is evaluated as follows: ones with peeling were ranked as B; and ones with peeling were ranked as D.

In addition, a total evaluation was made based on the evaluation of air bubble, the arithmetic mean roughness (Ra) of the surface of the lower surface, and the durability of the molding die. The total evaluation was tanked as follows: ones with no air bubble, with Ra of Rank A, and with durability of Rank B were ranked as Excellent (A); ones with no air bubble, with Ra of Rank B, and with durability tanked as B were ranked as Good (B); and ones with air bubble or with durability of Rank D were ranked as No good (D).

The evaluation results are shown in Table 2.

TABLE 2

| | Surface | | | | | | |
|---|---|---|---|---|---|---|---|
| | roughness | | | | | | |
| | after | Roughening process | | | | | |
| | polishing | of cover layer | | Glass molded article | | | |
| | process | Ra | RSm | | Ra of the lower | Durability of | Total |
| | (mm) | (μm) | (μm) | Air bubble | surface | molding die | evaluation |
| Example 1 | 5 | 0.01 | 0.03 | No | A | B | A |
| Example 2 | 5 | 0.1 | 0.25 | No | A | B | A |
| Example 3 | 8 | 0.2 | 0.4 | No | A | B | A |
| Example 4 | 10 | 0.25 | 0.5 | No | B | B | B |
| Comparative example 1 | 12 | 0.25 | 0.5 | No | B | D | D |

| | | | | | |
|---|---|---|---|---|---|
| Comparative example 2 | 5 | No roughening process | Yes | C | B |

The results of Examples 1 to 4 and the Comparative Examples 1 and 2 show that even after being long used, a peeling does not occur owing to the adhesion of the cover layer improved by the process in which the surface of the molding die base is made to have Ra of 10 nm or less by a polishing process and the cover layer is then formed. In any of Examples 1 to 4, an air bubble is not formed in the glass molded article, and the total evaluation was A or B, which evaluation confirms that the advantages of the present invention was brought out. It is further confirmed that when the arithmetic mean roughness (Ra) of the cover layer 34 was not more than 0.2 μm (Examples 1 to 3), the arithmetic average surface roughness (Ra) of the bottom surface of the glass molded article was not more than 0.1 μm, and whereby the results of the total evaluation was Excellent (A). The molding die of Comparative Example 1 had a poor durability, as for Comparative example 2, an air bubble was observed in the obtained glass molded article, and the both molding dies were ranked as Poor (D) in the total evaluation.

### DESCRIPTION OF THE NUMERALS

10, 30: Lower molding die
13: Molding die base
13a: Molding surface
14, 34, 44, 74: Cover layer
15, 35, 45, 75: Surface
20: Molten glass droplet
21: Concave part
25: Melting bath
26: Nozzle
27: Glass gob
28: Glass molded article
33: Lower molding die base
40: Upper molding die
43: Upper molding die base
50: Oscar polishing machine
51: Wrap
52: Work-piece
53: Polishing tool
60: Shot mirror-polishing machine
61: Abrasive agent
61c: Air bubble
62: Belt conveyor
63: Spraying device
70: Side molding die
73: Side molding die base

1. A method for manufacturing a molding die for molding a molten glass droplet, the method comprising, in order, the steps of:
machining the molding die to make a molding surface;
polishing the molding surface so that the molding surface has an arithmetic mean roughness Ra of 10 nm or less;
forming a cover layer containing at least one layer on the molding surface; and
roughening a surface of the cover layer.

2. The method of claim 1, wherein the step of polishing the molding surface includes the step of:
spraying abrasive agent made of an elastic body with a mean particle size of 0.3 to 0.5 mm and abrasive particles, the abrasive particles being laminated on the elastic body and having a mean particle size of 0.3 to 1.0 μm.

3. The method of claim 1, wherein in the step of roughening, the surface of the cover layer is roughened to have an arithmetic mean roughness Ra of 0.01 μm or more and a mean length of a roughness curve element RSm of 0.5 μm or less.

4. The method of claim 1, wherein in the step of roughening, the surface of the cover layer is roughened to have an arithmetic mean roughness Ra of 0.2 μm or less.

5. The method of claim 1, wherein at least one layer in the cover layer contains at least one element selected from the group consisting of chrome, aluminum, and titanium.

6. The method of claim 3, wherein the roughening step includes a wet etching process.

7. A method for manufacturing a glass gob, the method comprising the steps of:
dropping a molten glass droplet onto a lower molding die; and
cooling and solidifying the dropped molten glass droplet on the lower molding die,
wherein the lower molding die is manufactured by the method of claim 1.

8. A method for manufacturing a molded glass article, the method comprising the step of:
molding a molten glass droplet into the molded glass article by using a molding die manufactured by the method of claim 1.
